(19) United States
(12) Patent Application Publication
(10) Pub. No.: US 2020/0308876 A1
(43) Pub. Date: Oct. 1, 2020

(54) CABINET DOOR ADJUSTABLE ROD GUIDE

(71) Applicant: FATH, Inc., Orlando, FL (US)

(72) Inventors: Armin Fink, Ocoee, FL (US); William Kenneth Williams, Lexington, NC (US)

(21) Appl. No.: 16/834,744

(22) Filed: Mar. 30, 2020

Related U.S. Application Data
(60) Provisional application No. 62/826,143, filed on Mar. 29, 2019.

(51) Int. Cl. E05B 65/44; E05C 3/00

(52) U.S. Cl. CPC E05B 65/44; E05Y 2900/20; E05Y 2201/702; E05C 3/004

(57) ABSTRACT

An apparatus (100), including: a housing (106); female threads (138) recessed into a bottom end of the housing; a through-slot (162) oriented to transverse to a longitudinal extent (908) of the housing; and an adjustment mechanism (176) configured such that adjustment of the adjustment mechanism adjusts an amount of occlusion of the through-slot.

This application claims benefit of the Mar. 29, 2019 filing date of application 62/826,143 which is incorporated in its entirety by reference herein.

### FIELD OF THE INVENTION

The invention relates to a guide for a locking bar of a door. Specifically, the invention relates to a guide that can be pushed onto a threaded stud and locked in place with one motion and that includes an adjustable through-slot.

### BACKGROUND OF THE INVENTION

Conventional cabinet doors may be opened by rotating a handle from a closed position to an open position. Inside the cabinet an eccentric point on the handle is connected to a locking bar that extends from the eccentric point and through a guide. In the closed position an end of the locking bar extends past an inner perimeter of a frame surrounding the panel door. When the handle is rotated to the open position, the eccentric point pulls the end of the locking bar out of the frame, thereby disengaging the locking bar from the frame and freeing the cabinet door to swing open.

The guide provides structural support for the locking bar and ensures that the end of the locking bar aligns with the frame as necessary when the handle is moved to the closed position. Some conventional guides are mounted on a threaded stud that is secured to an inner surface of the cabinet door and protrudes into an interior of the cabinet. Guides with female threads must be threaded onto the threaded stud and the threads must cooperate so that the base of the guide abuts the inner surface of the panel when the guide is at an appropriate clocking position to receive the locking bar. Other guides may be secured to the stud with a nut, in which case access to the nut which is at least partially inside the guide must be provided. In this case the guide may include a first piece that is secured to the panel via the stud and a second piece that is secured to the first piece. Each of the above approaches requires positioning and or assembly that requires time and effort.

### BRIEF DESCRIPTION OF THE DRAWINGS

The invention is explained in the following description in view of the drawings that show:

FIG. 1 is a perspective view of a partial cutaway of an example embodiment of a guide.

FIG. 2 is a cutaway view of the guide of FIG. 1 installed on a threaded stud.

FIG. 3 is a side cross sectional view of the guide of FIG. 1 with the locking plungers in a first partially inserted position.

FIG. 4 is a side cross sectional view of the guide of FIG. 1 with the locking plungers in a second partially inserted position.

FIG. 5 is an exploded view of the guide of FIG. 1 with an alternate embodiment of the detent assembly.

FIG. 6 is a top view of the guide of FIG. 5.

FIG. 7 a cutaway view of an alternate example embodiment of a guide.

FIG. 8 is a side cross sectional view of the guide of FIG. 7.

FIG. 9 is a perspective view of an alternate embodiment of the guide.

FIG. 10 is a front view of the guide of FIG. 10.

FIG. 11 is side cross sectional view of the guide of FIG. 10.

FIG. 12 is a bottom view of the guide of FIG. 10.

FIG. 13 is a side cross sectional view of another alternate embodiment of the guide.

### DETAILED DESCRIPTION OF THE INVENTION

The present inventor has devised a unique and innovative guide that permits a user to install and lock the entire guide onto a threaded stud in a single motion. Moreover, an embodiment of the guide is equipped with a locking bar slot that can be adjusted to accommodate locking bars of different diameters or to permit adjustment of the alignment of the locking bar. The latter can be used to control an amount of force exerted by the locking bar on the cabinet frame, and hence a force with which the cabinet door is held closed, as well as to align the locking bar.

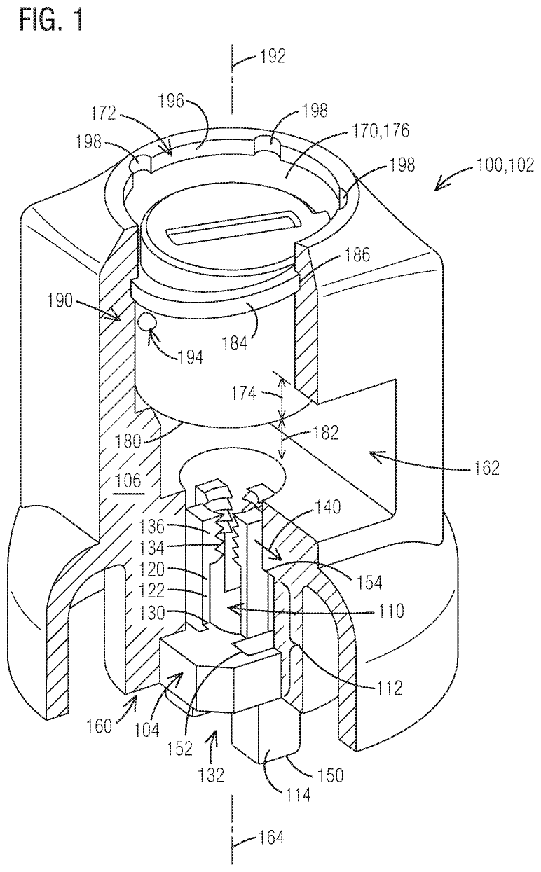

FIG. 1 is a perspective view of a partial cutaway of an example embodiment of a guide 100 in an uninstalled state. The guide 100 includes a housing assembly 102 that includes a stud assembly housing 104 that is optionally discrete from and assembled into a slot assembly housing 106. An example threaded stud is a ¼-20×0.75″ weld stud having male threads. The stud may be spot welded to a panel or door or the like.

The stud assembly housing 104 and/or the slot assembly housing 106 may be composed of a plastic, or more specifically a nylon. An example nylon includes polyamide and the like. The stud assembly housing 104 and/or the slot assembly housing 106 may be formed by any suitable process, for example, casting. The stud assembly housing 104 comprises a recess 110 and a locking plunger guide 112 in which a locking plunger 114 is disposed. In the uninstalled state the locking plunger 114 protrudes from the locking plunger guide 112 as shown. The stud assembly housing 104 further comprises at least one pawl 120 comprising an arm 122. The pawl 120 may be made of a metal, for example, stainless steel. A first end 130 of the arm 122 is secured to the stud assembly housing 104 at an inlet 132 of the recess 110. A locking feature 134 is disposed at second end 136 (e.g. a free end) of the arm 122 that projects into the recess. In the embodiment shown, the locking feature 134 comprises a female thread 138 configured to engage with a male thread of a stud inserted into the recess 110.

The pawl 120 is mounted to the stud assembly housing 104 in a cantilevered manner and can deflect outward in a lateral direction 140 to permit the female threads of the locking feature 134 to pass by the male threads of a threaded stud when the guide 100 is pressed onto the threaded stud. Once fully installed on the threaded stud, a resilience of the pawl 120 causes the pawl 120 to return to its original position, in which position the female threads of the pawl 120 will engage with the male threads of the threaded stud, thereby preventing removal of the guide 100 from the threaded stud.

During installation of the guide 100 on a threaded stud, the locking plunger 114 initially protrudes from the locking plunger guide 112 as is shown. A panel on which the threaded stud is disposed contacts a bottom 150 of the locking plunger 114 and pushes the locking plunger 114 into the locking plunger guide 112 as the threaded stud is inserted into the recess 110. As a leading edge 152 of the locking plunger 114 progresses farther into the locking plunger guide 112, the locking plunger 114 provides progressively more support behind the pawl 120. This, in turn, increases the pawl's resistance to the lateral deflection. The leading edge 152 of the locking plunger 114 may optional abut a stop 154 at an end of the locking plunger guide 112 when the locking plunger 114 is fully seated in the locking plunger guide 112. The locking plunger 114 will be fully seated when the panel abuts a bottom surface 160 of the housing assembly 102. This occurs when the threaded stud is fully inserted into the recess 110. Once fully seated, the locking plunger 114 provides the most support to the pawl 120, and hence, the pawl 120 exhibits its greatest resistance to the lateral deflection. Since lateral deflection would be necessary to disengage the female threads from the male threads of the threaded stud, the threaded stud is effectively locked inside the recess 110.

The guide 100 also includes a through-slot 162 oriented transverse to a longitudinal extent 164 of the recess 110 and configured to receive the guide rod. The guide further includes a splined spindle 170 and a spindle recess 172 configured to cooperate with the splined spindle 170 so that rotation of the splined spindle 170 adjusts a distance 174 the splined spindle 170 protrudes into the through-slot 162. The splined spindle 170 constitutes an adjustment mechanism 176 that translates into and out of the through-slot 162 when rotated. Hence, a bottom surface 180 of the splined spindle bounds at least a portion of the through-slot 162. The bottom surface 180 translates as the splined spindle is rotated and this changes a dimension 182 of the through-slot 162. The translation is made possible in this embodiment by spline 184 disposed on the splined spindle 170 that cooperates with a groove 186 in the housing assembly 102. Changing the dimension 182 changes a location of the locking bar relative to the panel on which the guide 100 is mounted.

The adjustment mechanism optionally further includes a detent assembly 190 configured to hold the splined spindle 170 in a detented clocking position relative to an axis of rotation 192 of the splined spindle 170. The detent assembly 190 may include a spindle ball 194 disposed in the splined spindle 170 and urged toward a spindle recess wall 196 of the spindle recess 172. One or more vertical grooves 198 may be disposed about the spindle recess wall 196 that receive the spindle ball 194, thereby acting as a detent to hold the splined spindle 170 in a detented clocking position. Example detented positions includes four positions, each generating 1.6 millimeters of translation of the splined spindle 170.

Removal of the guide 100 is a simple matter of unscrewing the guide 100 from the threaded stud 200 in the conventional manner.

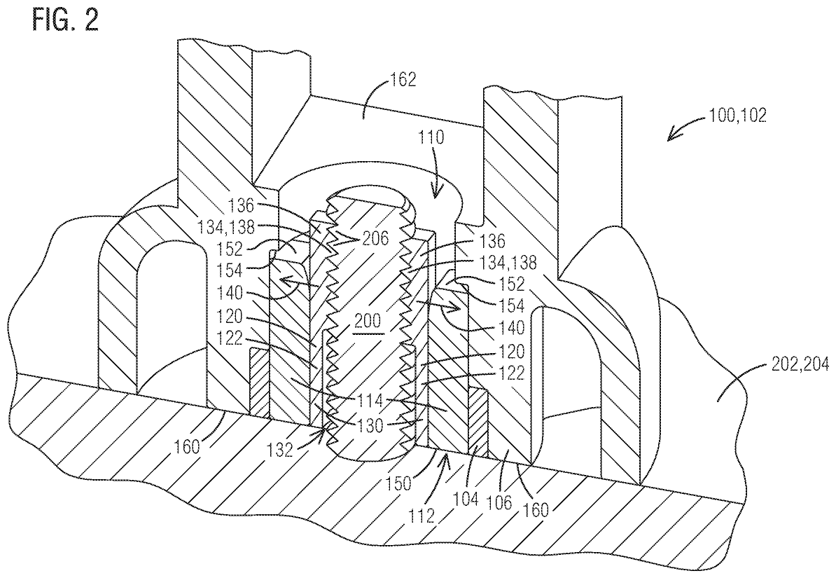

FIG. 2 is a cutaway view of the guide 100 of FIG. 1 installed on a threaded stud 200. The threaded stud 200 is associated with a surface 202 of a panel 204 or other structure. The threaded stud 200 is aligned with the recess 110 and the guide 100 is lowered onto the threaded stud 200. The threaded stud 200 enters the recess 110 and the surface 202 contacts the bottom 150 of the locking plunger 114. Further lowering of the guide 100 causes the surface 202 to push the locking plunger 114 into the locking plunger guide 112 while the threaded stud 200 moves farther into the recess 110.

The female threads 138 at the second end 136 of the pawl 120 must deflect laterally in lateral direction 140 for the male threads 206 to pass by. The pawl 120 deflects where unsupported by the locking plunger 114 through its own resilience.

Initially, most or all of the pawl 120 is unsupported by the locking plunger 114 and hence the second end 136 of the pawl 120 readily deflects laterally to accept the threaded stud 200. However, as the locking plunger 114 travels farther into the locking plunger guide 112, progressively more of the pawl 120 is supported. This renders the pawl 120 progressively more resistant to the lateral deflection. The pawl 120, the locking feature 134, the locking plunger 114, and the bottom surface 160 of the housing assembly 102 are configured to cooperate with each other to allow the locking feature 134 to deflect enough to permit a full seating of the guide 100 on the surface 202, but once fully seated, locks the guide 100 to the threaded stud 200 with enough force to remain on the threaded stud 200 during normal operation.

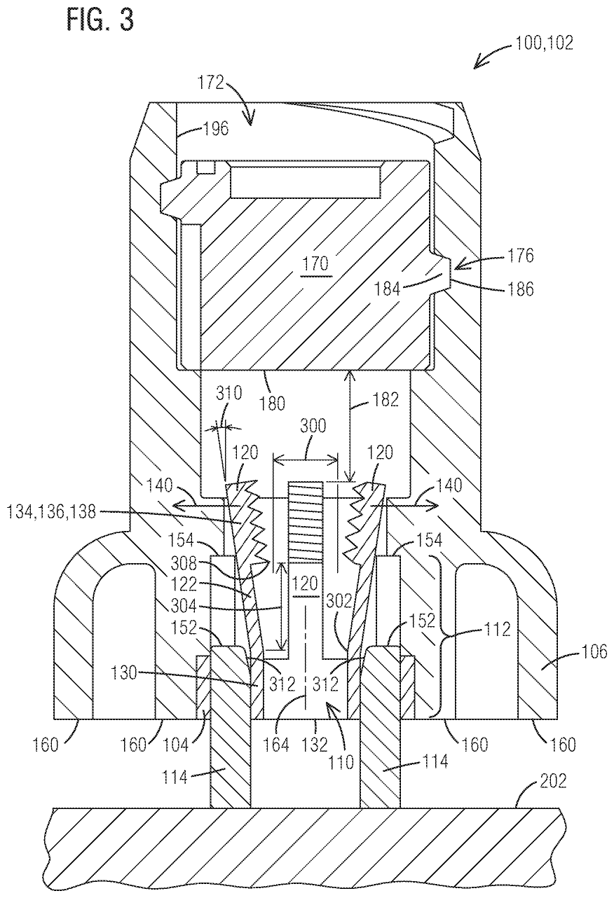

FIG. 3 is a side cross sectional view of the guide of FIG. 1 with the locking plungers 114 in a first partially inserted position. The portion protruding of the locking plunger 114 just reaches the surface 202 and the threaded stud (not shown) would already be partly in the recess 110. A threaded stud 200 having a diameter 300 would clear the female thread 138. With the leading edge 152 of the locking plunger 114 in this position, a bend 302 is formed in the arm 122 at the location shown. This results in a distance 304 between the bend and an innermost point 308 of the female threads 138. The innermost point 308 is the point where the female thread 138 and the male threads of the threaded stud 200 will make contact. Distance 304 is relatively large compared to when the locking plunger 114 is farther inserted. Accordingly, an unsupported length of the arm 122 from the bend 302 to the second end 136 is relatively large. Hence, a deflection angle 310 of the arm 122 is relatively small. With a large moment arm created by distance 304 and a small deflection angle 310, the pawl 120 provides relatively less resistance to the lateral deflection required to pass the threaded stud 200. The pawl 120 may optionally include a relief 312 such as a chamfer or a radius. This helps increase a radius of the bend 302 and enables the locking plunger 114 to travel into the locking plunger guide 112 more readily, thereby reducing the force necessary to push the guide 100 downward onto the threaded stud 200.

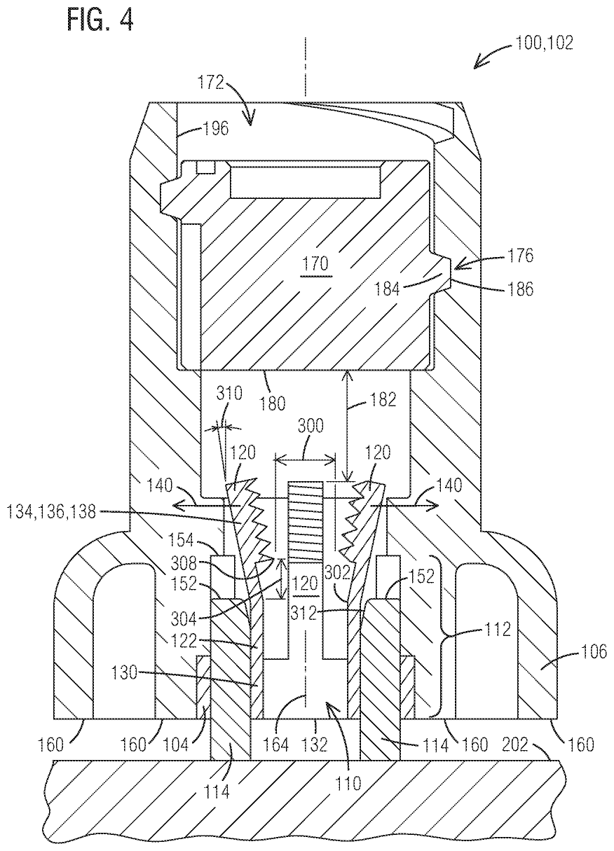

FIG. 4 is a side cross sectional view of the guide 100 of FIG. 1 with the locking plungers 114 in a second partially inserted position that is farther inserted than the first partially inserted position. Distance 304 is relatively small compared to when the locking plunger 114 is inserted less. Accordingly, an unsupported length of the arm 122 from the bend 302 to the second end 136 is relatively small. Hence, a deflection angle 310 of the arm 122 is relatively large. With a small moment arm created by the relatively smaller distance 304 and a large deflection angle 310, the pawl 120 provides relatively more resistance to the lateral deflection required to pass the threaded stud 200. Hence, the pawl 120 provides progressively increasing resistance to insertion as the guide 100 approached a fully installed position. Upon reaching the fully installed position, the pawl 120 provides enough resistance to the lateral deflection that it holds the guide 100 in position on the threaded stud 200 securely enough to remain ensure its operation as a locking bar guide.

Full insertion of the locking plunger 114 into the locking plunger guide 112 may constitute a fully installed configuration if no structure associated with the threaded stud 200 like the panel has a surface 202 to operate as described herein. Moreover, fully inserting the locking plunger 114 in the locking plunger 114 is not required to satisfactorily secure the guide 100 to the threaded stud 200. Full insertion simply insures the maximum resistance to removal of the guide 100 from the threaded stud 200. In addition, male and female threads are not required. Any interlocking geometry known to the Artisan will suffice so long as it comports with the principles set forth herein.

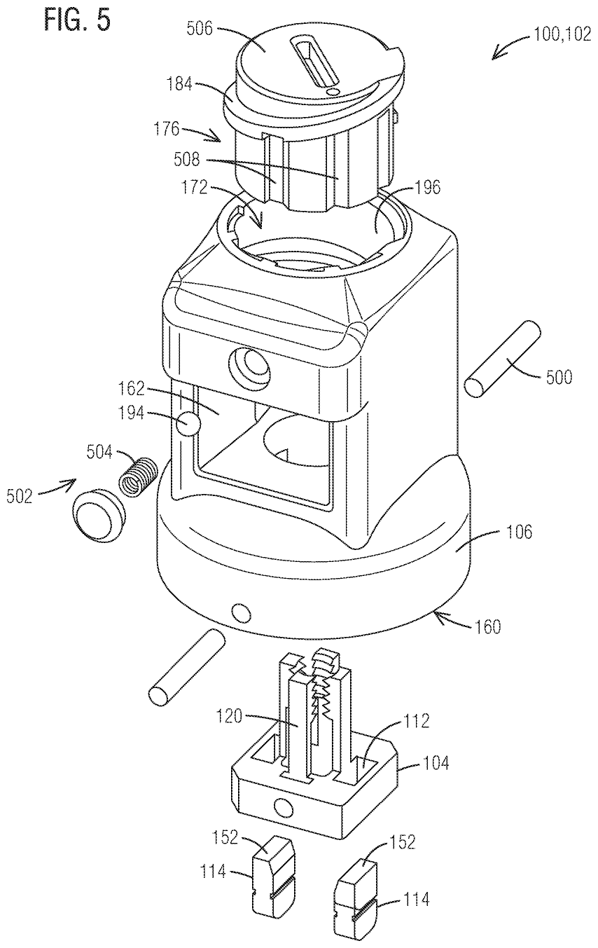

FIG. 5 is an exploded view of the guide 100 with an alternate embodiment of the detent assembly. In this embodiment, the stud assembly housing 104 fits into the slot assembly housing 106 and the two are held together via a pin 500 or similar fastener known to the Artisan. The pin 500 may be composed of any suitable material such as stainless steel. Alternately, the assembly may be welded together. This embodiment of the detent assembly 502 provides the same detent function as does detent assembly 190. However, in this embodiment, the spindle ball 194 and spring 504 are disposed in the slot assembly housing 106. The spindle ball 194 is urged toward the splined spindle 506 and interacts with various grooves 508 to secure the splined spindle 506 in one or more detented positions.

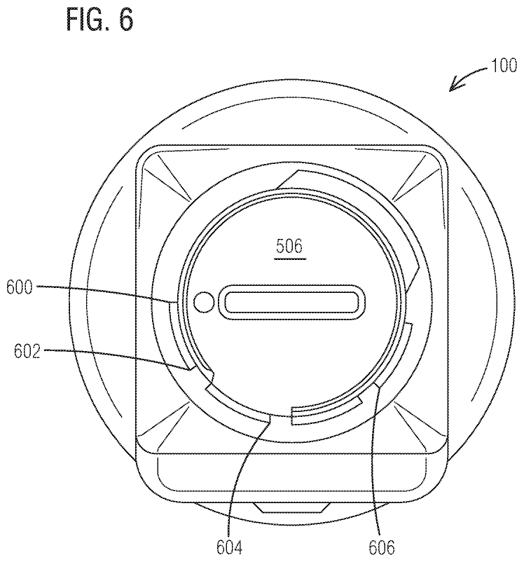

FIG. 6 is a top view of the guide 100 of FIG. 5. Visible are various clocking positions 600, 602, 604, 606.

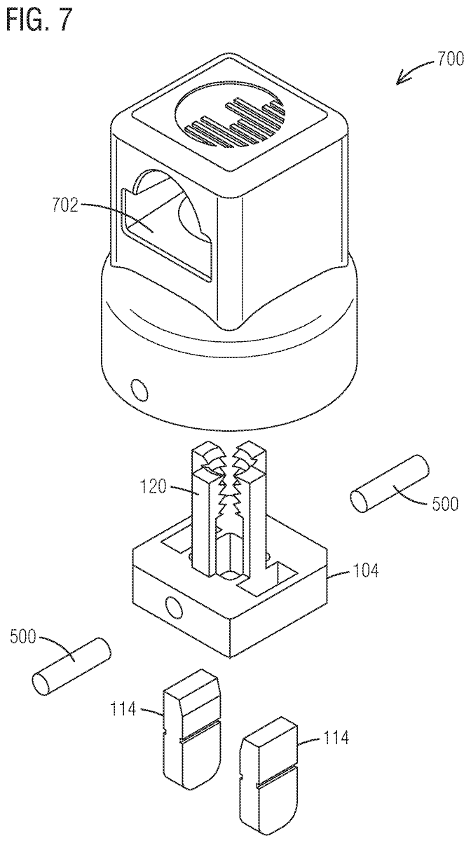

FIG. 7 an exploded view of an alternate example embodiment of a guide 700. In this embodiment the detent assembly is omitted, and the through-slot 702 is configured slightly different. The remainder of the components operate as disclosed for the embodiment of FIG. 1.

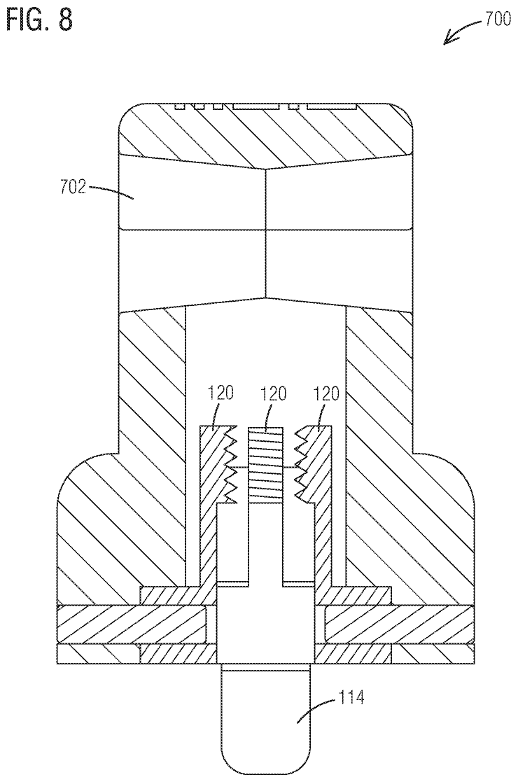

FIG. 8 is a side cross sectional view of the guide 700 of FIG. 7. The through-slot 702 is tapered slightly to allow for ease of installation of the locking bar of various shapes, including round and rectangular.

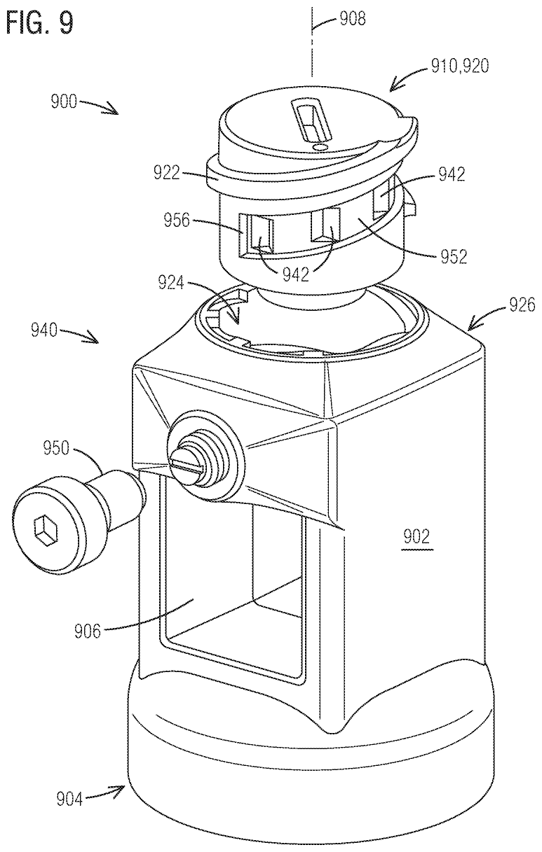

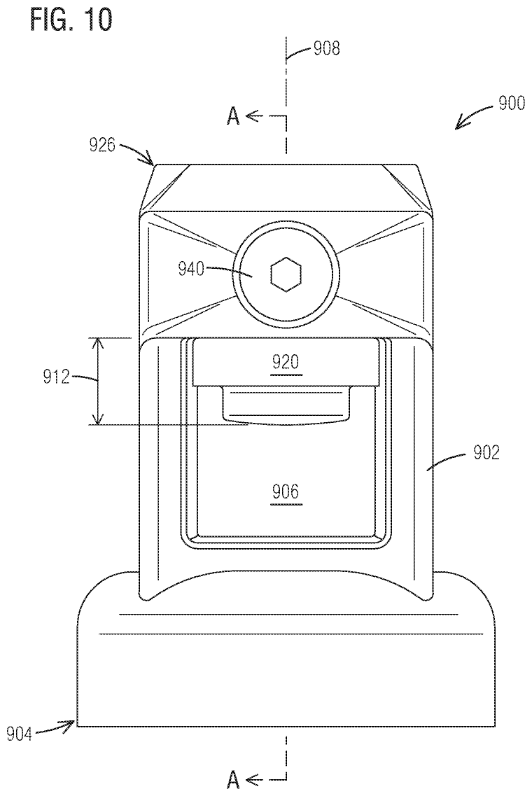

FIGS. 9-10 show an alternate embodiment of the guide 900. The guide 900 includes a housing 902, female threads recessed into a bottom end 904 of the housing 902, the through-slot 906 oriented transverse to a longitudinal extent 908 of the housing 902, and an adjustment mechanism 910 configured such that adjustment of the adjustment mechanism 910 adjusts an amount of occlusion of the through-slot 906. In this example embodiment, the guide 900 is simply rotated onto the threaded stud 200 for installation. The adjustment mechanism 910 includes the splined spindle 920 having a spline 922 that advances the adjustment mechanism 910 along the longitudinal extent 908 of the housing 902 when the splined spindle 920 is rotated. Advancement along the longitudinal extent 908 adjusts the amount of occlusion 912. The housing 902 includes a spindle recess 924 that opens at a top end 926 of the housing 902 and also opens to the through-slot 906. The spline 922 of the splined spindle 920 cooperates with the spindle recess 924 so rotation of the splined spindle 920 moves the splined spindle 920 along the longitudinal extent 908, thereby adjusting a distance the splined spindle 920 protrudes into the through-slot 906 and the associated amount of occlusion 912.

The guide 900 further includes a detent assembly 940 configured to hold the splined spindle 920 in a detented position. The detent assembly 940 includes plural detents 942 arranged at different circumferential positions on the splined spindle 920, and a biased element in the housing 902 that is urged toward the splined spindle 920 and which engages whichever detent 942 of the plural detents 942 is rotated into position in front of the biased element as the splined spindle 920 is rotated. In this example embodiment, the plural detents 942 are arranged in a helix on the splined spindle 920. A pitch of the helix may match a pitch of the spline 922 so that each detent 942 arrives in front of the biased element as the splined spindle 920 is rotated and thereby advanced. The adjustment mechanism 910 further includes a stud 950 that protrudes into a helical recess 952 in which the plural detents 942 are disposed. (A cap screw embodiment of the stud 950 is shown withdrawn from the housing 902 and a flathead version is shown installed in the housing 902.) The stud 950 abuts a first end wall of the helical recess 952 (a maximum occlusion stop) when the splined spindle 920 reaches a maximum amount of occlusion of the through-slot 906. The stud 950 abuts a second end wall 956 of the helical recess 952 (a minimum occlusion stop) when the splined spindle 920 reaches a minimum amount of occlusion of the through-slot 906.

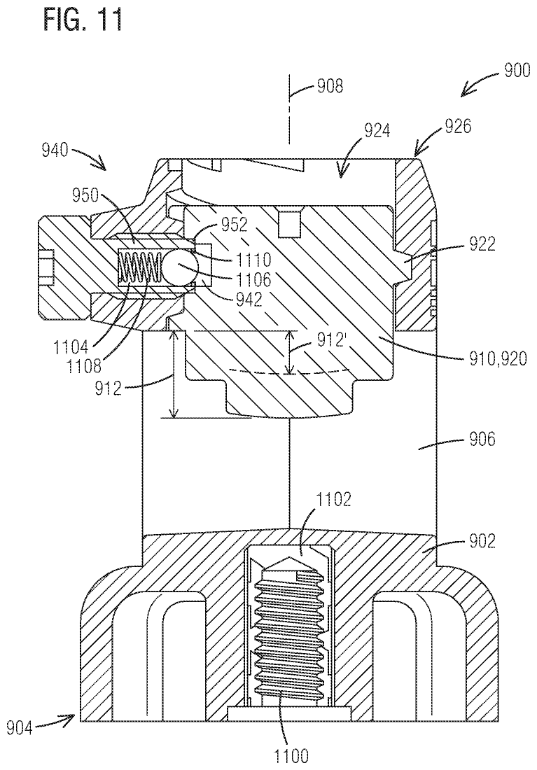

FIG. 11 is side cross sectional view of the guide 900 along line A-A of FIG. 10. Visible are the female threads 1100 recessed into the bottom end 904. In this example embodiment, the female thread 1100 are disposed in a nut 1102 that is recessed into the housing 902. Also visible is the stud 950 that is threaded into the housing 902 and which protrudes into the helical recess 952. This enables the stud 950 to contact the end walls of the helical recess 952, thereby limiting the amount of rotation and associated occlusion 912 of the through-slot 906. In this example embodiment, the stud 950 includes an interior volume 1104 that optionally houses the biased element 1106 (e.g. a ball) and optionally also houses a resilient element 1108 that biases the biased element 1106 into whichever detent 942 is rotated in front of the biased element 1106. The stud 950 optionally includes a lip 1110 configured to retain the biased element 1106 therein. This permits removing the stud 950, the biased element 1106, and the resilient element 1108 as a unit, thereby simplifying assembly and disassembly.

As can be seen in FIG. 11, if the splined spindle 920 were rotated such that the splined spindle 920 moved upwards (as seen in FIG. 11), the amount of occlusion 912 would be reduced to an amount of occlusion 912′. This adjustment permits adjustment of a position of a bar/rod passing through the through-slot 906 which, in turn, adjusts an amount of force with which a door is held closed.

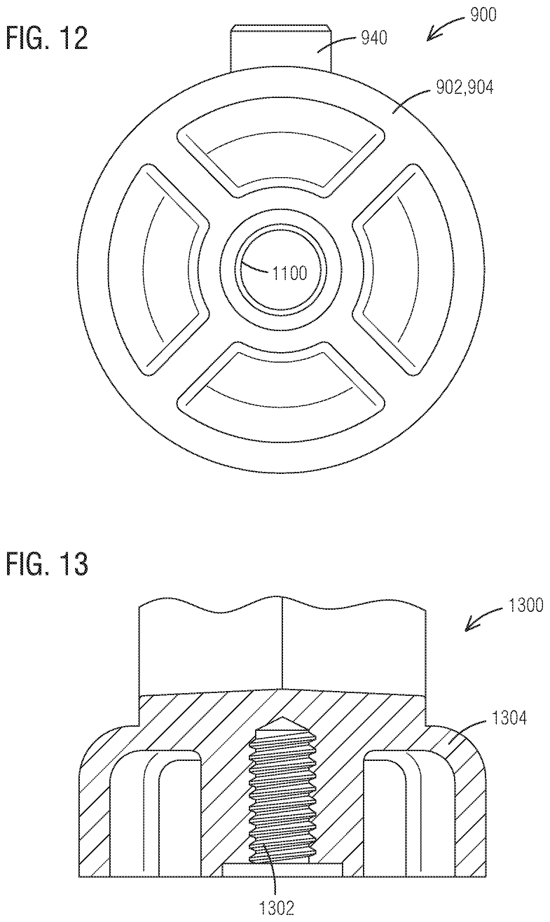

FIG. 12 shows a bottom view of the guide 900. Visible are the bottom end 904 of the housing 902 into which the female threads 1100 are recessed.

FIG. 13 shows an alternate embodiment of the guide 1300 where the female threads 1302 are formed directly in the housing 1304.

As is disclosed above, the inventor has created an inventive guide that enables simple installation of the guide and flexible positioning of the guide rod, thereby providing a savings of time and effort.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An apparatus, comprising:
a housing;
female threads recessed into a bottom end of the housing;
a through-slot oriented transverse to a longitudinal extent of the housing; and
an adjustment mechanism configured such that adjustment of the adjustment mechanism adjusts an amount of occlusion of the through-slot.

2. The apparatus of claim 1, wherein the adjustment mechanism comprises a splined spindle comprising a spline that advances the adjustment mechanism along the longitudinal extent of the housing when the splined spindle is rotated, wherein advancement along the longitudinal extent adjusts the amount of occlusion.

3. The apparatus of claim 2, wherein the adjustment mechanism comprises a spindle recess that opens at a top end of the housing, wherein the splined spindle is disposed in the spindle recess.

4. The apparatus of claim 1, wherein the adjustment mechanism further comprises:
a spindle recess disposed at a top end of the housing; and
a splined spindle that cooperates with the spindle recess so rotation of the splined spindle moves the splined spindle along the longitudinal extent, thereby adjusting a distance the splined spindle protrudes into the through slot.

5. The apparatus of claim 2, further comprising a detent assembly configured to hold the splined spindle in a detented position.

6. The apparatus of claim 5, wherein the detent assembly comprises:
a detent in the splined spindle; and
a biased element in the housing that is urged into the detent when the splined spindle is in the detented position.

7. The apparatus of claim 2, further comprising a detent assembly configured to hold the splined spindle in plural detented positions and comprising:
plural detents arranged at different circumferential positions on the splined spindle; and
a biased element in the housing that is urged toward the splined spindle and which engages whichever detent of the plural detents is rotated into position in front of the biased element as the splined spindle is rotated.

8. The apparatus of claim 7, wherein the plural detents are arranged in a helix on the splined spindle, wherein a pitch of the helix matches a pitch of the spline.

9. The apparatus of claim 8, wherein the splined spindle comprises a helical recess, wherein the plural detents are arranged in the helical recess, wherein the adjustment mechanism comprises a stud that protrudes into the helical recess, wherein the stud abuts a first end wall of the helical recess when the splined spindle reaches a maximum amount of occlusion of the through-slot, and wherein the stud abuts a second end wall of the helical recess when the splined spindle reaches a minimum amount of occlusion of the through-slot.

10. The apparatus of claim 9, wherein the stud comprises an interior volume that houses the biased element and also a resilient element that biases the biased element into the detent.

11. The apparatus of claim 6, wherein the detent assembly further comprises a stud, and a resilient element that biases the biased element into the detent.

12. The apparatus of claim 2, wherein the adjustment mechanism comprises a maximum occlusion stop on the splined spindle that prevents rotation of the splined spindle beyond a maximum amount of occlusion of the through-slot, and a minimum occlusion stop on the splined spindle that prevents rotation of the splined spindle beyond a minimum amount of occlusion of the through-slot.

13. The apparatus of claim 12, further comprising a stud secured to the housing that protrudes toward the splined spindle and abuts the maximum occlusion stop when the splined spindle reaches the maximum amount of occlusion, and abuts the minimum occlusion stop when the splined spindle reaches the minimum amount of occlusion.

14. An apparatus, comprising:
a housing;
female threads recessed into a bottom end of the housing;
a splined spindle configured to rotate in a splined spindle recess disposed at a top of the housing, and
a through-slot disposed between the female threads and the splined spindle recess and oriented transverse to a longitudinal extent of the housing;
wherein rotation of the splined spindle adjusts an amount of occlusion of the through-slot.

15. The apparatus of claim 14, wherein the splined spindle recess opens into the through-slot, and wherein the splined spindle protrudes into and thereby occludes the through-slot by an amount determined by a rotational position of the splined spindle.

16. The apparatus of claim 14, wherein the splined spindle comprises a spline that advances the splined spindle along the longitudinal extent of the housing when the splined spindle is rotated, wherein advancement along the splined spindle adjusts the amount of occlusion.

17. The apparatus of claim 14, further comprising:
plural detents arranged at different circumferential positions on the splined spindle; and
a biased element that is urged toward the splined spindle and which engages whichever detent of the plural detents is rotated into position in front of the biased element as the splined spindle is rotated.

18. The apparatus of claim 17, further comprising:
a stud disposed in the housing; and
a resilient element between the stud and the biased element that biases the biased element toward the splined spindle.

19. The apparatus of claim 18, wherein the splined spindle further comprises:
a maximum occlusion stop on the splined spindle that abuts the stud to prevent rotation of the splined spindle beyond a maximum amount of occlusion of the through-slot, and a minimum occlusion stop on the splined spindle that abuts the stud to prevent rotation of the splined spindle beyond a minimum amount of occlusion of the through-slot.

20. The apparatus of claim 19, wherein the splined spindle comprises a helical recess into which the stud protrudes, wherein the maximum occlusion stop comprises a first end wall of the helical recess, and wherein the minimum occlusion stop comprises a second end wall of the helical recess.
